(19) United States
(12) Patent Application Publication
(10) Pub. No.: US 2021/0190291 A1
(43) Pub. Date: Jun. 24, 2021

(54) OPTICAL SYSTEM WITH LED LIGHT SOURCES

(71) Applicant: GUANGZHOU UNIONLUX ELECTRONIC TECHNOLOGY CO., LTD., Guangzhou (CN)

(72) Inventors: Cheng HUANG, Guangzhou (CN); Guoping CHEN, Guangzhou (CN)

(21) Appl. No.: 17/195,117

(22) Filed: Mar. 8, 2021

Related U.S. Application Data
(63) Continuation of application No. PCT/CN2019/083080, filed on Apr. 17, 2019.

(30) Foreign Application Priority Data
Sep. 12, 2018 (CN) 201821491228.5

(51) Int. Cl. F21V 5/04; G02B 27/30; F21V 3/04

(52) U.S. Cl. CPC F21V 5/04; F21Y 2115/10; F21V 3/049; G02B 27/30

(57) ABSTRACT

An optical system with LED light sources includes an LED light source array, a collimating lens array and a condensing lens that are sequentially arranged. The collimating lens array is in one-to-one correspondence with the LED light sources and is used to collimate the beams emitted by the LED light sources into nearly parallel lights. A Gaussian scattering sheet is provided between the collimating lens array and the condensing lens, and is used to perform Gaussian scattering on the collimated nearly parallel lights. Then the lights are focused on a preset surface by the condensing lens so as to form light spots of Gaussian distribution. Compared with the prior art, the invention has the beneficial effects that the brightness at the beam center can be effectively guaranteed, the beams can be uniformized, the process is simple, and the cost is low.

### CROSS REFERENCE TO RELATED APPLICATIONS

The present application is a Continuation application of International Application No. PCT/CN2019/083080, filed on Apr. 17, 2019, which claims priority from Chinese Patent Application No. 201821491228.5 filed on Sep. 12, 2018, all of which are hereby incorporated herein by reference.

### TECHNICAL FIELD

The invention relates to the technical field of LED light sources, in particular to an optical system with LED light sources.

### BACKGROUND ART

Based on a high intensity discharge (HID) light source, a conventional stage lamp collects light emitted by a light source through a reflection cup and projects the light by an imaging lens, so as to achieve stage lighting or create various stage scene effects. In general, a lamp using such a light source is high in energy consumption, low in luminous efficiency, short in service life, and has certain risk factors due to high voltage in a lamp bulb filled with high-voltage metal halides.

In recent years, a light-emitting diode (LED) light source has been used as a green, pollution-free, clean and energy-saving light source with a long service life. With continuous development of techniques, luminous flux generated by each watt of electric power has increased year by year, and the process has become more mature, which meet the conditions of large-scale promotion and application of LED.

The LED used in the stage lamp industry requires high power, large luminous flux output, strong directionality, and good uniformity. To meet these characteristics, a conventional LED packaging technology usually encapsulates several LED chips on a substrate to form a high-power LED light source. The conventional technology has a relatively simple packaging process, but the light-emitting heat of the light source is high and dense, which is to the disadvantage of heat dissipation of the system and greatly limits high-power driving and luminous efficiency of a single LED chip.

According to the stage lamp industry, lamps are classified into a beam lamp, a soft light lamp, a pattern lamp, and a three-in-one lamp and the like. The beam lamp features small beam angles, high brightness (not uniform) of a beam center, a long illumination distance, and a sharp beam edge, and is usually used for spatial dynamic effects on the stage. The soft light lamp is a floodlight with no obvious beams or light spot edges, and is mainly used for stage coloring, light supplementing, stage lighting and emotional rendering and the like. The pattern lamp requires high light spot illumination uniformity, large beam angles, and clear effects of projected patterns. As a relatively popular lamp in the current market, the three-in-one lamp integrates the characteristics of the beam lamp, the soft light lamp and the pattern lamp, and utilizes an optical lens with a large zoom range to realize features of small angles as a beam lamp and large angles when switched from the beam lamp into the pattern lamp. Therefore, demands for the light source are different according to different requirements of various lamps on the stage.

The Chinese patent application No. 201310038767.9 discloses an LED light source system and an LED lighting device, in which the LED light source system includes a multi-color LED light source array, a collimating lens array corresponding to the light source array, a fly-eye lens group, and a condensing lens. The multiple beams emitted by the LED light source are collimated into nearly parallel lights by the collimating lens array, then the nearly parallel lights pass through the fly-eye lens group for light uniformization, and finally the lights are focused by the condensing lens on a predetermined surface to form uniform light spots with a certain illumination area. According to the solution, the light spots become uniform after light uniformization by the fly-eye lens group, and thus the brightness at the beam center is low, which is insufficient for the beam lamp that requires high central brightness, small beam angles and a long projection distance. In addition, the fly-eye lens is high in processing cost and processing difficulty. During a production, installation, and debugging process, the oppositely arranged fly-eye lens units need to be strictly overlapped; otherwise it is easy to cause defects such as the reduction of luminous efficiency or unsatisfactory optical effect of the light source.

### SUMMARY

In order to overcome the existing technical deficiencies mentioned above, the invention provides an optical system with LED light sources, which can effectively ensure the brightness at the beam center and uniformize the beams, and has a simple process and low cost.

According to the present invention, the optical system with LED light sources includes an LED light source array, a collimating lens array and a condensing lens that are sequentially arranged. The collimating lens array is in one-to-one correspondence with the LED light sources and is used to collimate the beams emitted by the LED light sources into nearly parallel lights. A Gaussian scattering sheet is provided between the collimating lens array and the condensing lens, and is used to perform Gaussian scattering on the collimated nearly parallel lights. Then the lights are focused on a preset surface by the condensing lens so as to form light spots of Gaussian distribution.

The invention is mainly applied to a multi-light source module of a monochromatic LED light source array, such as a pure white LED with multiple light sources. Since the LED light source is a surface light source and the LED light source itself is uniform in luminance, and the LED light source has better luminous efficiency, longer product life and better lighting effects compared with the traditional metal halide lamp. The collimating lens array is in a one-to-one correspondence with the LED light source array, and is mainly used to collimate the beams emitted by the LED light source into nearly parallel lights for output. The Gaussian scattering sheet has a function of scattering the beams, in which the beams can be diffused at a certain angle. The light energy at the beam center can be ensured to be the maximum, i.e., the maximum brightness, and the light energy diffused from two sides of the beam center is gradually reduced, i.e., the brightness is gradually reduced, and then the beam can be scattered and uniformized while ensuring that the brightness at the beam center is satisfied.

According to the optical system with the LED light sources in the prior art, when the fly-eye lens or the Gaussian scattering sheet are not used for light uniformization processing, splicing gaps between the plurality of beams generated by the plurality of LEDs can be displayed out of the imaging lens group, and bright alternating with dark formed by splicings of the plurality of LED small beams can be displayed near a light outlet. After the fly-eye lens group is used for light uniformization, the light intensity at the center of the light spot is greatly weakened and an effect of light spots with uniform brightness is formed due to optical integration effect of the fly-eye lens. However, since the light intensity at the center of the light spot is similar to the light intensity at the edge of the light spot, there is still a few possibilities of bright alternating with dark formed by splicings of small beams.

According to the invention, nearly parallel beams after collimation are subjected to uniformized scattering by the Gaussian scattering sheet when passing through the Gaussian scattering sheet to form scattered small beams. Due to blurred superimposition at the edge, the scattered small beams are mixed to form a large beam, which has high light energy density in the center and high brightness while the light energy diffused to both sides of the center gradually decreases and the brightness gradually decreases. The large beam is focused on the preset surface through the condensing lens to form Gaussian distributed light spots. Due to Gaussian properties, the weakening of the light intensity at the beam center is lower than the weakening at the beam center by the fly-eye lens, the light intensity of the Gaussian light spots formed after Gaussian scattering has a gradual change from center to edge; due to scattering characteristics of the Gaussian scattering sheet and that scattering particles are extremely small, which are much smaller than the fly-eye lens, the light uniformization effect is better. At the same time, Gaussian diffusion and partial superposition of the plurality of LED small beams can weaken the splicing relationship between the plurality of small beams and eliminate the phenomenon of bright alternating with dark. Therefore, the invention has the beneficial effects that not only ensuring the central brightness of the beam, but also uniformizing the beam. In addition, the Gaussian scattering sheet has relatively simple process requirements, and does not need strict position requirements in the production and installation process. Therefore, the cost can be effectively controlled, inputs of manpower and material resources are reduced, and the subsequent maintenance is simple.

Further, the Gaussian scattering sheet is a transmission-type opaque optical material.

Further, the Gaussian scattering sheet is a transmission-type diffuser sheet, a scattering sheet, or a ground glass, and has scattering characteristics of Gaussian scattering.

Further, a light-emitting surface of the Gaussian scattering sheet has Gaussian scattering characteristics. The Gaussian scattering sheet has Gaussian scattering characteristics at least on the light-emitting surface, which mainly ensures that when passing through the Gaussian scattering sheet, the collimated beams can be performed Gaussian scattering and formed into a uniformized large beam that ensures the illuminance at the center of the light spot.

Further, both the light-emitting surface and the light-incident surface of the Gaussian scattering sheet have scattering characteristics of Gaussian scattering.

Further, the energy distribution of the light scattered by the Gaussian scattering sheet satisfies the formula:

$$P ( θ ) = {P}_{0} exp [ ( - \frac{1}{2} ) {( \frac{θ}{σ} )}^{2} ] ,$$

where P(θ) is a radiation density of light scattered by the Gaussian scattering sheet in any direction at a θ angle; P₀ is the radiation density in an original propagation direction of the light, that is, the radiation density of light scattered by the Gaussian scattering sheet in any direction at θ angle; σ is a standard deviation angle of Gaussian scattering, and the standard deviation σ determines the magnitude of the distribution.

The value of the standard deviation angle σ of Gaussian scattering determines the light radiation density of the Gaussian distribution. Due to energy conservation, when a beam is scattered by the Gaussian scattering sheet, a total area formed between a light density curve of the Gaussian distribution and a horizontal axis is consistent. When σ is larger, the density P₀ in the original propagation direction of light is smaller, the drop on both sides of the distribution curve is smoother, i.e., the scattering ability of the scattering sheet is stronger; when σ is smaller, the original optical density P₀ is larger, the Gaussian curve is more concentrated, i.e., the scattering ability of the scattering sheet is weaker. Since P₀ is the radiation density in the original propagation direction of light, P(θ) is the radiation density of the light scattered by the Gaussian scattering sheet in any angular direction, and P₀ is greater than or equal to P(θ), it can also be proved that the density of the original propagation direction of the scattered beam is large and the brightness is high, the beam density at the edge is small and the brightness is low, thereby ensuring the brightness at the beam center.

Further, in order to ensure the range of light emitting effect, the standard deviation angle σ of Gaussian scattering is 2 to 15 degrees when selecting the Gaussian scattering sheet.

Further, in order to ensure the effect of the collimated beams, a diffusion angle range of beams collimated by the collimating lens array after emitted from each LED light source is 2 to 30 degrees.

Compared with the prior art, the invention has the beneficial effects that the brightness at the beam center can be effectively guaranteed, the beams can be uniformized, the process is simple, and the cost is low.

### BRIEF DESCRIPTION OF THE DRAWINGS

FIG. 1 is a schematic structural view of an optical system according to the present invention.

FIG. 2 is a schematic structural view of a Gaussian scattering sheet according to the present invention.

FIG. 3 is an effect view of Gaussian scattering by the Gaussian scattering sheet.

FIG. 4 is a schematic view of a Gaussian scattering principle model of the Gaussian scattering sheet.

### DETAILED DESCRIPTION OF EMBODIMENTS

The present invention will be described in further detail below with reference to accompanying drawings in order to provide a clearer understanding of the purpose, technical solution and advantages of the present invention.

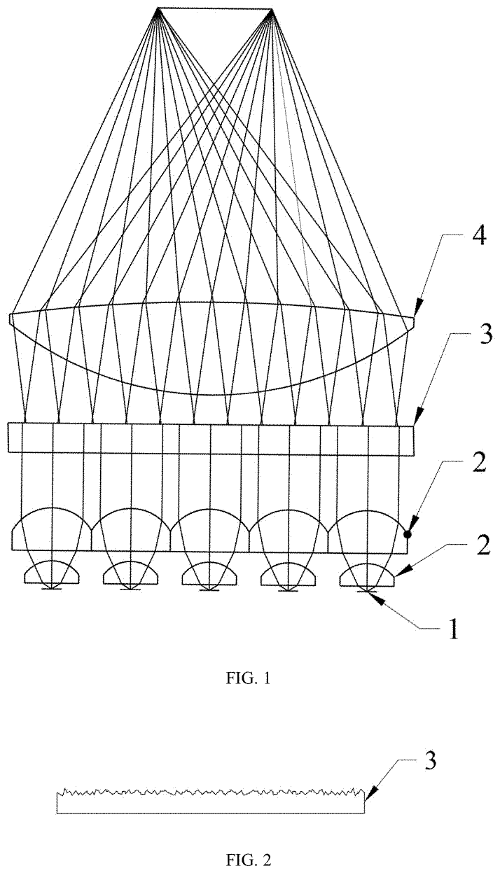

As shown in FIG. 1, an optical system with LED light sources, including an LED light source array 1, a collimating lens array 2 and a condensing lens 4 that are sequentially arranged. The collimating lens array 2 is in one-to-one correspondence with the LED light sources and is configured to collimate the beams emitted by the LED light sources into nearly parallel lights. A Gaussian scattering sheet 3 is provided between the collimating lens array 2 and the condensing lens 4, and is configured to perform Gaussian scattering on the nearly parallel lights collimated by the collimating lens array 2 so as to form a large beam. Then the lights are focused on a preset surface by the condensing lens 4 to form light spots of Gaussian distribution.

The collimating lens array 2 is in a one-to-one correspondence with the LED light source array 1, in such a way that the beams emitted by the LED light sources are collimated into nearly parallel lights for output, and a diffusion range of the collimated beams is 2 to 30 degrees. The Gaussian scattering sheet 3 is mainly used to perform Gaussian scattering on the collimated beams, uniformize the beams into large beams with Gaussian distribution, so that the beams can be uniformized while satisfying the central brightness.

As shown in FIG. 2, the Gaussian scattering sheet 3 is a projected diffuser sheet, and has scattering characteristics of Gaussian scattering.

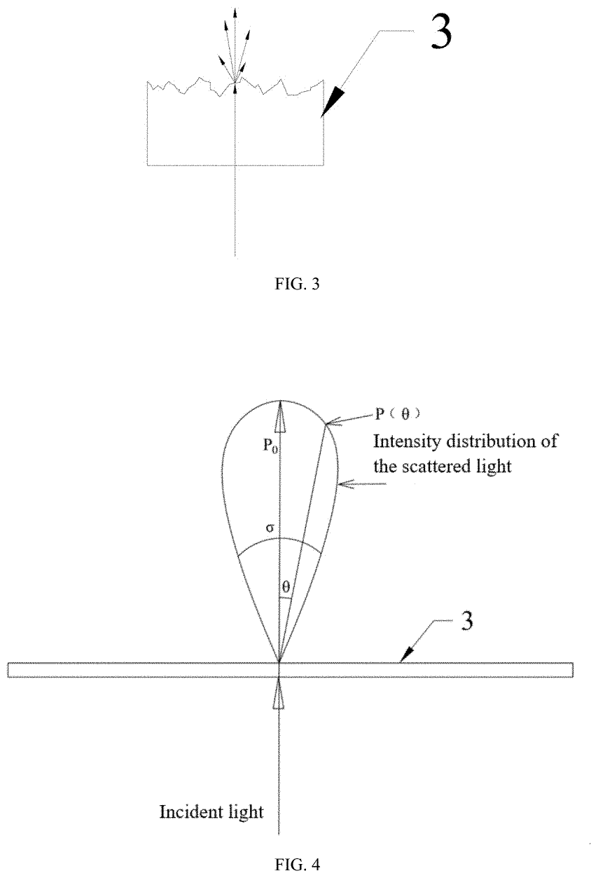

As shown in FIG. 3, the surface of the Gaussian scattering sheet 3 with Gaussian scattering characteristics is consistent with a light-emitting direction of the LED light source, and such surface is a light-emitting surface while the other surface is a light-incident surface, which can allow the beams passing through the Gaussian scattering sheet 3 to be subjected to Gaussian scattering and formed into a uniform large beam with guaranteed illuminance at the center of the light spot.

As shown in FIG. 4, a formula showing an energy distribution relationship of the light scattered by the Gaussian scattering sheet 3 is:

$$P ( θ ) = {P}_{0} exp [ ( - \frac{1}{2} ) {( \frac{θ}{σ} )}^{2} ] ,$$

where P(θ) is a light radiation density in the direction of angle θ; P₀ is a radiation density in an original propagation direction of the light; and σ is a standard deviation angle of Gaussian scattering.

When the light radiation density P(θ) of the Gaussian scattering sheet 3 in the direction of angle θ and the radiation density P₀ in the original propagation direction of light are known, the above formula can be used to calculate the standard deviation angle σ of Gaussian scattering, i.e., an angle range of the scattered beams scattered by the Gaussian scattering sheet 3, which can also prove that the energy distribution of the light conforms to the curve of the Gaussian function. At the same time, since P₀ is the radiation density in the original propagation direction of light, P(θ) is the radiation density of the light scattered by the Gaussian scattering sheet 3 in any angular direction, P₀ is greater than P(θ) when θ is not equal to 0, and P(θ₁)<P(θ₂) when |θ₁|>|θ₂|, it can also be proved that the density of the original propagation direction of the scattered beam is large and the brightness is high, the beam density at the edge is small and the brightness is low, thereby ensuring the brightness at the beam center. Similarly, when the standard deviation angle σ of Gaussian scattering and the radiation density P₀ in the original propagation direction of the light are known, the light radiation density P(θ) of the Gaussian scattering sheet 3 in the direction of angle θ can also be calculated by the above formula.

The standard deviation angle σ of Gaussian scattering is 2 to 15 degrees.

Compared with the prior art, the invention has the beneficial effects that the brightness at the beam center can be effectively guaranteed, the beams can be uniformized, the process is simple, and the cost is low.

1. An optical system with LED light sources, comprising:
an LED light source array;
a collimating lens array which is in one-to-one correspondence with the LED light sources, and configured to collimate beams emitted by the LED light sources into nearly parallel lights; and
a condensing lens,
wherein the LED light source array, the collimating lens array and the condensing lens are sequentially arranged, and
wherein a Gaussian scattering sheet is provided between the collimating lens array and the condensing lens, and is configured to perform Gaussian scattering on the collimated nearly parallel lights, and the beams then are focused on a preset surface by the condensing lens so as to form light spots in Gaussian distribution.

2. The optical system with LED light sources according to claim 1, wherein the Gaussian scattering sheet is a transmission-type opaque optical material.

3. The optical system with LED light sources according to claim 1, wherein the Gaussian scattering sheet is a transmission-type diffuser sheet, a scattering sheet, or a ground glass, and has scattering characteristics of Gaussian scattering.

4. The optical system with LED light sources according to claim 3, wherein a light-emitting surface of the Gaussian scattering sheet has Gaussian scattering characteristics.

5. The optical system with LED light sources according to claim 3, wherein both the light-emitting surface and a light-incident surface of the Gaussian scattering sheet have scattering characteristics of Gaussian scattering.

6. The optical system with LED light sources according to claim 1, wherein energy distribution of a light scattered by the Gaussian scattering sheet satisfies a formula:
$$P ( θ ) = {P}_{0} exp [ ( - \frac{1}{2} ) {( \frac{θ}{σ} )}^{2} ] ,$$
wherein P(θ) is radiation density of the light scattered by the Gaussian scattering sheet in any angular direction, P₀ is the radiation density in an original propagation direction of light, and σ is a standard deviation angle of Gaussian scattering.

7. The optical system with LED light sources according to claim 6, wherein the standard deviation angle σ of Gaussian scattering is 2 to 15 degrees.

8. The optical system with LED light sources according to claim 1, wherein a diffusion angle range of beams collimated by the collimating lens array after emitted from each LED light source is 2 to 30 degrees.
